(19) United States
(12) Patent Application Publication
(10) Pub. No.: US 2008/0300740 A1
(43) Pub. Date: Dec. 4, 2008

(54) GPS autopilot system

(76) Inventor: Ron Wayne Hamburg, Sacramento, CA (US)

Correspondence Address: RON WAYNE HAMBURG, 5518 DATE AVENUE, SACRAMENTO, CA, 95842, US

(21) Appl. No.: 11/807,412

(22) Filed: May 29, 2007

(51) Int. Cl. G05D 1/08

(52) U.S. Cl. 701/11; 701/3

(57) ABSTRACT

The GPS (Global Positioning System) Autopilot System utilizes approximately fourteen (14) to twenty-four (24) microprocessors, depending on the size of the aircraft. These microprocessors computer control fuel and airspeed, ailerons, elevators, rudder and breaking automatically by following pre-programmed GPS fixes stored in the aircraft's onboard GPS database, and making the required mechanical system adjustments so that the real-time GPS fixes become the virtual GPS fixes when the aircraft moves. The GPS database is programmed during an identical flight plan, flown by an experienced pilot. During this flight, GPS coordinates and UTC time is recorded and stored in GPS database. All the stored GPS coordinates or fixes can be used or a portion of the flight fixes can be used, such as just the approach and landing sequence of GPS fixes. Once the chosen data is determined, the onboard database computer will control the aircraft's airspeed, yaw, pitch, roll and breaking to insure the aircraft passes through the GPS fixes that were recorded during the programming flight. The GPS Autopilot System accomplishes this by sighting the pre-programmed GPS fixes that are twelve (12) to thirty (30) seconds ahead of the aircraft's real-time GPS fix, and aiming or guiding the aircraft toward and through the programmed virtual GPS fixes.

### CROSS-REFERENCE TO RELATED APPLICATIONS

“Not Applicable”

### STATEMENT REGARDING FEDERALLY SPONSORED RESEARCH

“Not Applicable”

### REFERENCE TO SEQUENCE LISTING

“Not Applicable”

### BACKGROUND OF THE INVENTION

The GPS Autopilot System is related to the existing VOR (VHF Omni-directional Range) autopilot systems that are widely used throughout the commercial aviation industry. The routes established between airports are called Victor Airways and this radio navigation aid provides the guidance for autopilot systems onboard the aircraft. The VOR autopilot microprocessors (5-Intel 80386 CPU's) used in these systems computer control rudder, ailerons, elevators, and airspeed with electrical and hydraulic reactions to keep aircraft on Victor Airway course. The VOR autopilot system is mainly used during the level flight phase of the flight plan.

The GPS (Global Positioning System) autopilot system can be used in combination with the VOR autopilot systems and would be an improvement in the systems ability to fly all phases of flight such as: taxiing, take-off, ascent, level, descent, approach and landing of the aircraft with no pilot assistance.

### SUMMARY OF THE INVENTION

The GPS Autopilot system differs from current GPS aircraft avionics in several ways. Most GPS units available show position with respect to a database of terrain maps with the destination airport shown on maps also. The maps display airports, terrain, towers and obstacles and a small picture of an aircraft which represents the pilots position. For landing purposes a GPS overlay that has been certified can be used for runway approach phase. The instrumentation is not computer controlled or has any autopilot capabilities.

This new GPS autopilot system will work in combination with existing VOR autopilot systems and control aircraft yaw, pitch, roll and breaking during all phases of flight.

Once the GPS data base has been programmed during an identical flight, the virtual flight plan is a sequence of GPS fixes and when the aircraft begins to move and fly the real-time GPS fixes received will become synonomous with the autopilot aiming the aircraft toward and passing through the virtual programmed fixes. This can be accomplished by sighting on the GPS fixes that are twelve (12) to thirty (30) seconds ahead of the aircrafts real-time GPS fixes. This procedure will result in an identical flight to the programmed flight.

The GPS autopilot could have commercial and military aircraft applications at airports and aircraft carriers at sea.

### BRIEF DESCRIPTION OF THE DRAWINGS

Here in these drawings, the GPS (Global Positioning System) Autopilot System is depicted. The drawings show and describe the data flow from instrumentation to microprocessors and then to mechanical systems that fly and stop the aircraft. The autopilot system will receive real-time GPS coordinates and microprocessors will energize mechanical systems to guide the aircraft and match the pre-programmed GPS coordinates.

FIG. 1 is a block diagram schematic showing the instrument data input and the resulting mechanical equipment output. The drawing shows: (1) the instrumentation input, (2) GPS receiver, (3) GPS Database, (4) 8-Intel 80386 central processing units and 1-PCI clock, (5) 16-Intel 80386 CPUs (6) mechanical systems that fly and stop the aircraft.

FIG. 2 is an airport diagram and aircraft depicting an autopilot computer controlled landing. (1) aircraft with GPS Autopilot System, (2) Runway 30.

FIG. 3 is a side view of an aircraft landing. The aircraft is receiving real-time GPS coordinates and onboard computer relays mechanical system commands that guide aircraft through recorded GPS coordinates 12 to 30 seconds ahead of the aircrafts real-time position. (1) The aircraft, (2) GPS coordinates at runway marker, (3) Runway 30.

FIG. 4 is an isometric view of an aircraft landing on the carrier deck. The Legend explains how the new compass heading is determined with the aligned GPS receivers 1 and 2. (1) GPS receiver, (2) GPS receiver, (3) aircraft, (4) Flight Deck, (5) The Bridge.

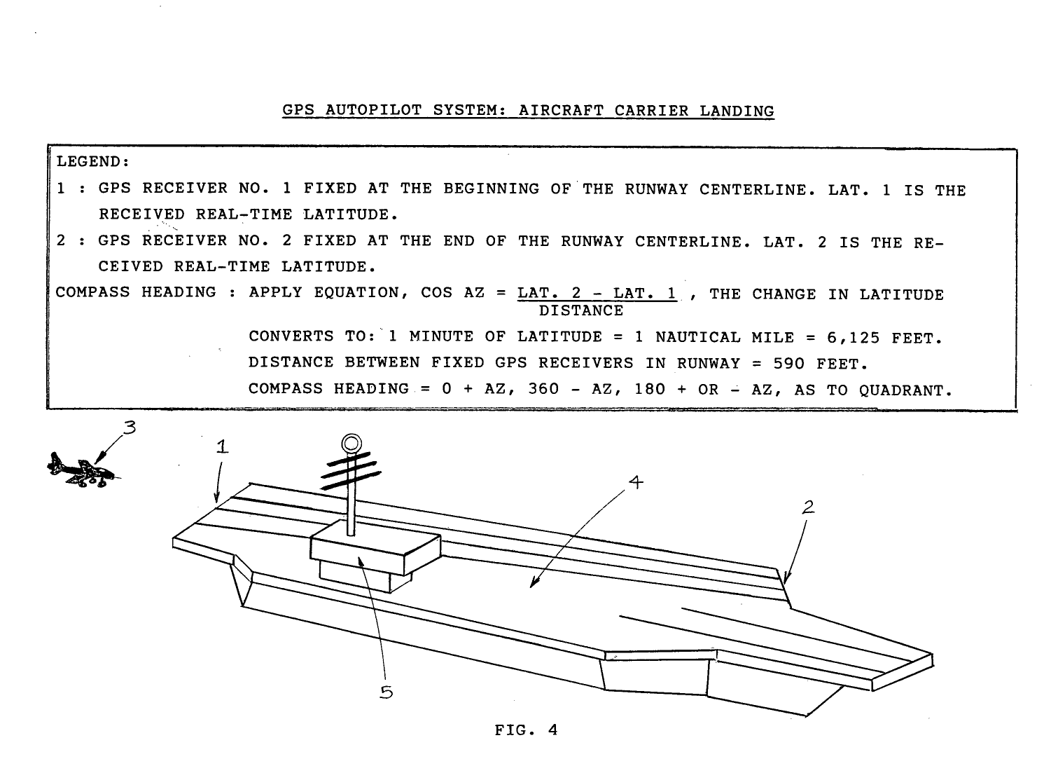

FIG. 5 is a plan view of the pre-programmed carrier and the real-time carrier. (1) Virtual carrier deck, (2) Real-time carrier deck, (3) Virtual compass heading, (4) Real-time compass heading with pre-programmed altitude data.

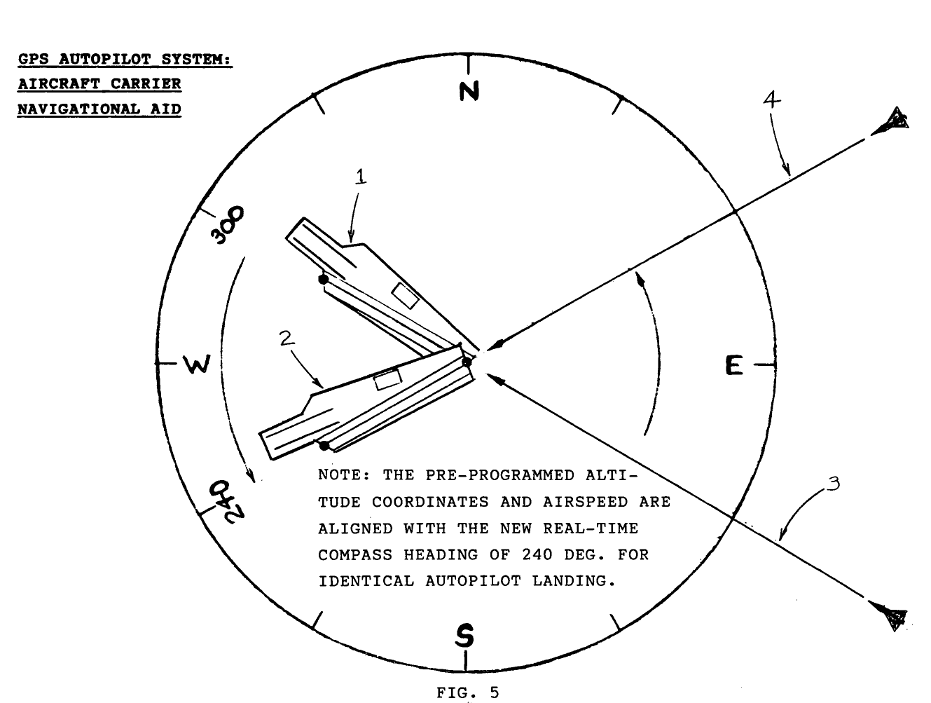

### DETAILED DESCRIPTION OF THE INVENTION

The GPS Autopilot System can be described as a navigation aid for aircraft, that automatically controls airspeed, yaw, pitch, roll and wheel breaking during the various phases of flight: taxiing, take-off, ascent, level, descent, approach and landing. This is accomplished by first flying a proposed flight plan with that aircraft by an experienced pilot, and recording and storing these GPS coordinates in an onboard computer. All or a portion of these GPS coordinates can be used as the virtual flight plan.

Once the virtual flight is determined, for an example, just the approach and landing sequence. The real-time GPS coordinates will be compared with the virtual GPS coordinates and through microprocessor automatic control of the rudder, ailerons, elevators and fuel injectors the aircraft will be aimed at virtual GPS coordinates twelve (12) to thirty (30) seconds ahead of the aircraft's real-time position. This will result in an identical approach and landing as previously flown by a pilot and then GPS coordinates recorded and stored in onboard database.

In summary the aircraft is flown toward and through a virtual sequence of GPS coordinates, while monitoring its own real-time GPS coordinates. If there is a variance in virtual GPS fixes and real-time fixes then the autopilot will automatically control mechanical systems to bring aircraft on course.

The primary instrumentation used by the GPS Autopilot System is the GPS receiver that receives radio transmissions from the orbiting satellites. The three (3) accellerometers used in system, give reinforcing data to the aircrafts position.

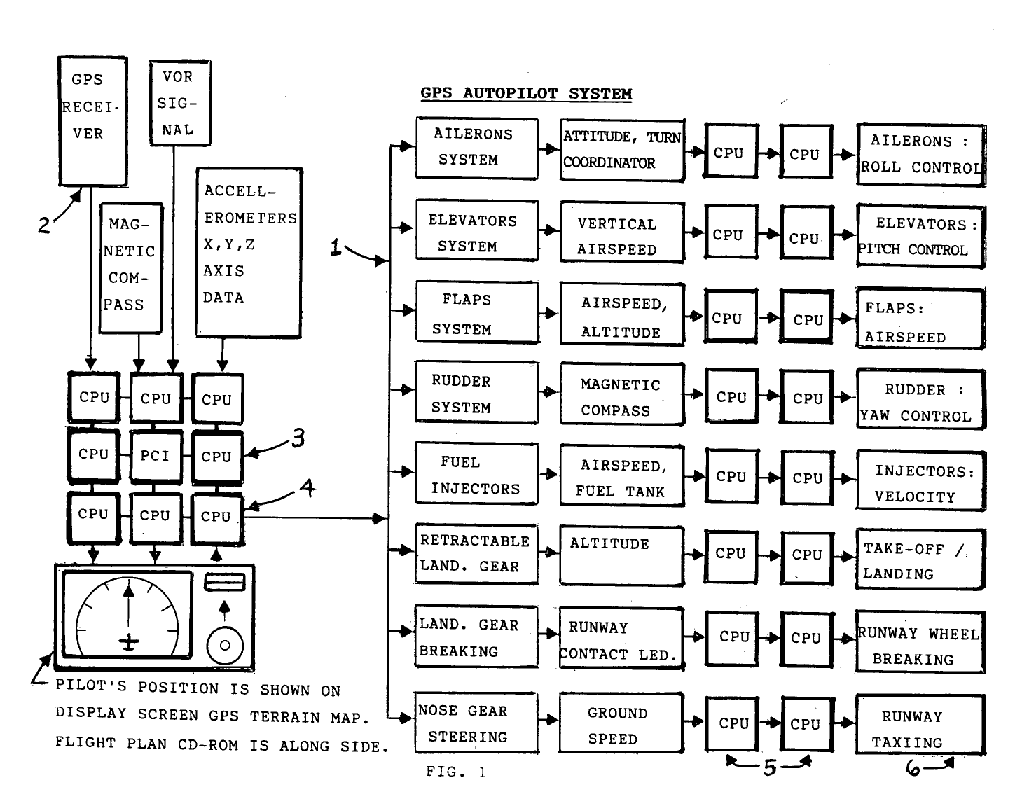

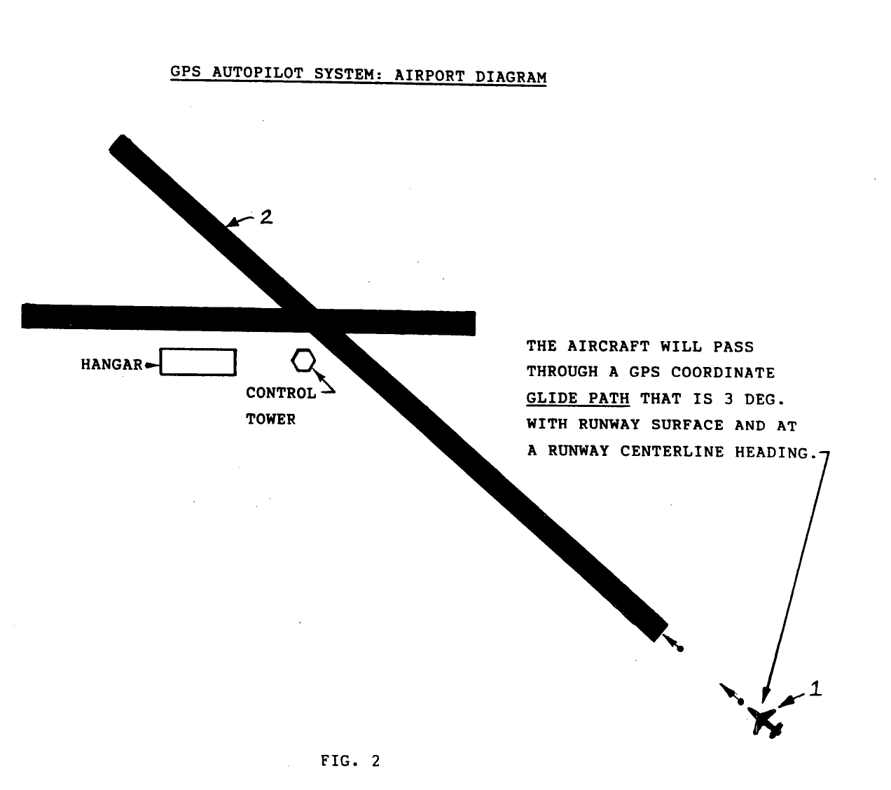

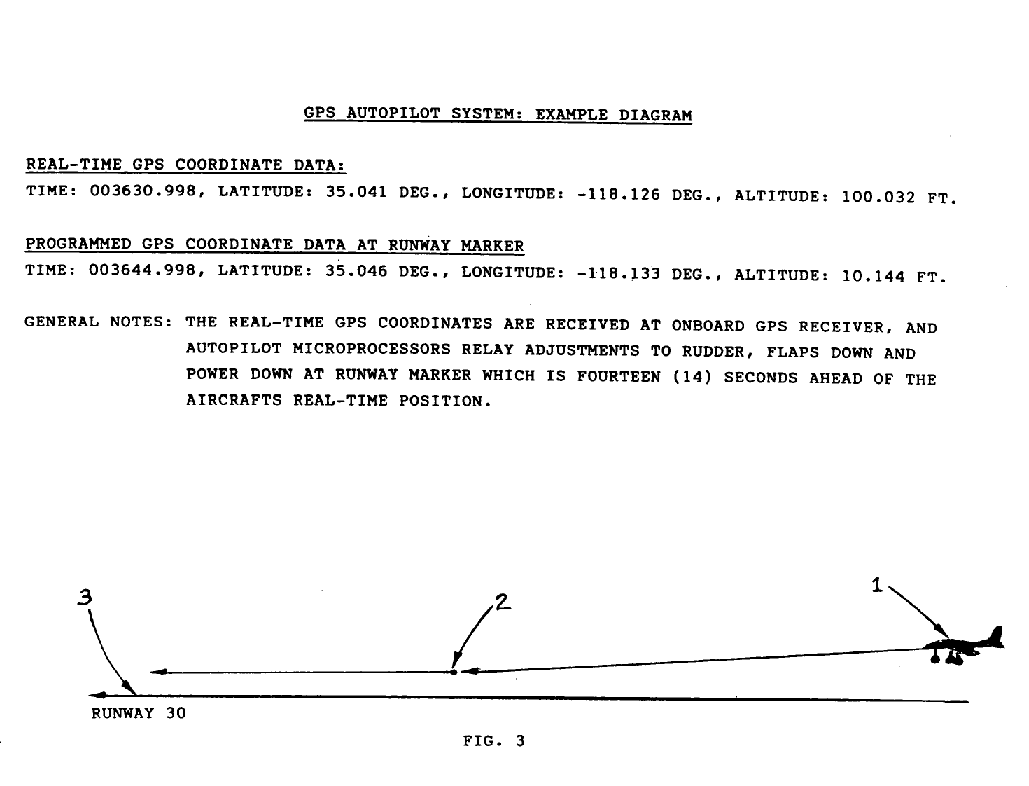

1.) I claim all rights to the invention of the process of navigating an aircraft with an autopilot system that uses Global Positioning System coordinates and/or accellerometers, three (3) used, to automatically computer control airspeed, yaw, pitch, roll, and breaking during an entire flight or portion of a flight as shown and described in FIG. 1, FIG. 2, and FIG. 3 of the drawings.

2.) I claim all rights to the invention of the improvement to existing autopilot systems that are VOR (VHF-omni-directional range) instrumentation. The improvement includes the addition of a GPS receiver input and three (3) accellerometers used to identify the aircraft's real-time position and programmed position. This data is then used to automatically control airspeed, yaw, pitch, roll, and breaking of the aircraft, while flown through a pre-programmed flight. This is depicted in FIG. 1, FIG. 2, and FIG. 3 of the drawings.

3.) I claim all rights to the invention of the process and procedure of recording and storing Global Positioning System coordinate data and/or accellerometer data to then be used in an autopilot system that automatically flies an aircraft.
